(19) United States
(12) Patent Application Publication
(10) Pub. No.: US 2007/0277637 A1
(43) Pub. Date: Dec. 6, 2007

(54) Lead screw assembly

(76) Inventor: Stewart E. Gardner, Bristol, IN (US)

Correspondence Address: R. TRACY CRUMP, P.O. BOX 604, 32790 DUNN ROAD, NEW CARLISLE, IN, 46552, US

(21) Appl. No.: 11/805,260

(22) Filed: May 22, 2007

Related U.S. Application Data
(60) Provisional application No. 60/802,335, filed on May 22, 2006.

(51) Int. Cl. F16H 1/24

(52) U.S. Cl. 74/424.71

(57) ABSTRACT

The lead screw assembly uses a traveler nut which includes a second “nut” screw in meshed contact with the lead screw to transfer the load on the lead screw assembly to thrust bearings. The nut screw is rotational disposed within the nut housing and journaled between a pair of thrust bearings. The orientation of the nut screw to the lead screw and the operative engagement between lead screw and nut screw allows a portion of the load to be transferred to the thrust bearings, thereby reducing the sliding friction of the traveler nut under load. Consequently, the majority of the load is carried by the thrust bearings, which enhances the power efficiency of the lead screw assembly.

### BACKGROUND OF THE INVENTION

Lead screws are used in a variety of applications to convert rotational movement into linear movement, which translates torque into thrust. A typical lead screw assembly consists of a threaded screw shaft and a traveler nut. Rotation of the screw moves the traveler nut along the length of the screw shaft. The lead screw assembly is powered by a motor that turns the screw shaft. As the motor generates torque, the rotating screw pushes the nut along the screw shaft, producing linear thrust.

Typically, developments in lead screw design have been targeted at providing improved power efficiency and movement precision. In certain applications, movement precision is secondary to power efficiency. For example, lead screw assemblies are commonly used to extend and retract slide-out rooms in recreational vehicles. Improved efficiency of the lead screw assembly means that small electrical motors can be used to extend and retract the slide-out room, which saves space and cost. While improved power efficiency is highly desirable, precision movement of the lead screw assembly is not critical. Conventional lead screw assemblies with the desired power efficiency are often over kill in high load, low precision lead screw applications, such as in slide-out rooms. Ball screw assemblies for example are very efficient and precise, but cost prohibitive for such applications.

### SUMMARY OF THE INVENTION

The present invention provides a lead screw assembly for high load, low precision applications. The lead screw assembly embodying the present invention uses a traveler nut which includes a second “nut” screw in meshed contact with the lead screw to transfer the load on the lead screw assembly to thrust bearings. The nut screw is rotationally disposed within the nut housing and journalled between a pair of thrust bearings. The orientation of the nut screw to the lead screw and the operative engagement between lead screw and nut screw allows a portion of the load to be transferred to the thrust bearings, thereby reducing the sliding friction of the traveler nut under load. Consequently, the majority of the load is carried by the thrust bearing, which enhances the power efficiency of the lead screw assembly.

The other advantages of the lead screw assembly as embodied in the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the lead screw assembly of this invention;

FIG. 2 is an exploded view of the lead screw assembly of FIG. 1;

FIG. 3 is a sectional view of the lead screw assembly of FIG. 1 taken along line 3-3;

FIG. 4 is a sectional view of the lead screw assembly of FIG. 1 taken along line 4-4;

FIG. 5 is a perspective view of a slide-out room in a recreational vehicle with portions cut away to illustrate the use of the lead screw assembly of FIG. 1; and

FIG. 6 is a partial sectional view of the lead screw assembly of FIG. 1 illustrating the meshed engagement of the lead screw and nut screw.

### DESCRIPTION OF THE PREFERRED EMBODIMENT

Referring now to the drawings, reference numeral 10 generally designates an embodiment of the lead screw assembly of this invention. Lead screw assembly 10 includes a lead screw 20 and traveler nut 30. Lead screw 20 is fabricated from any ferrous, non ferrous or composite material that can operate as a wear or bearing surface. Lead screw 20 includes a shaft 22 and a continuous helical thread 24. Traveler nut 30 is operatively mounted on lead screw 20 for reciprocal movement along its length.

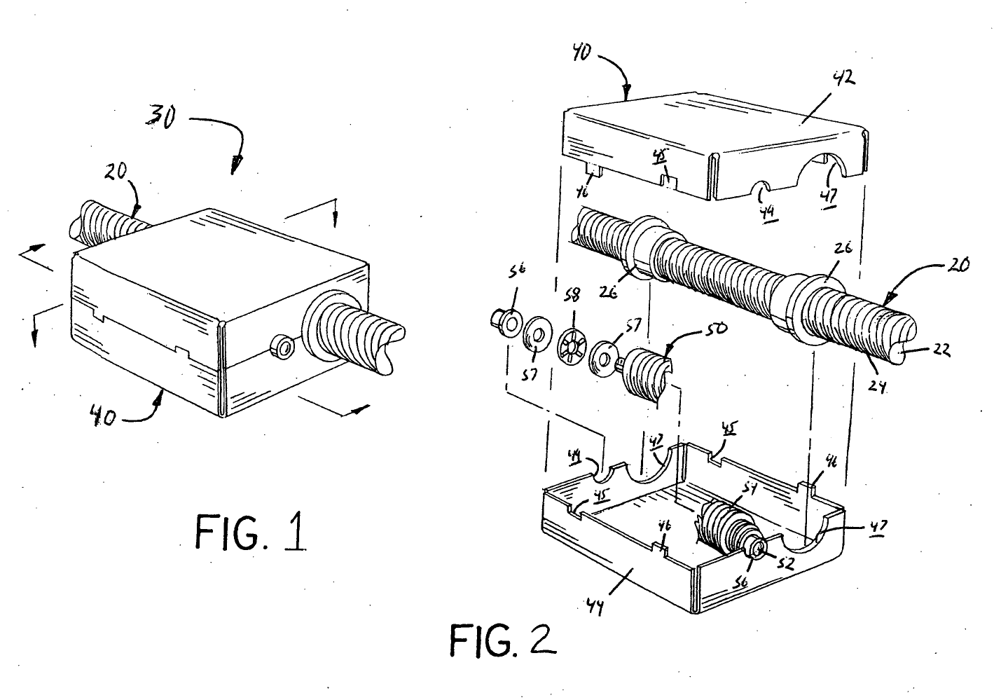

As shown in FIGS. 1 and 2, traveler nut 30 includes a box shaped metal housing 40, which defines an interior 41. Housing 40 is constructed from stamped heavy gauge sheet metal or other suitable materials. Housing 40 is formed by two shell halves 42 and 44. Each shell half 42 and 44 has rectangular side, end and bottom walls. Shelf halves 24 and 26 are typically joined by welds or other suitable fasteners and methods. Ideally, shell halves 42 and 44 have alignment notches 45 and tabs 46 formed along the edges of their side walls as shown. The end walls of each shell half 42 and 44 have semi-circular notches 47, which form opposite lead screw openings when the shell halves are joined together. Lead screw 20 extends through bushings 26, which are seated in screw openings at opposite ends of housing 40.

A second “nut” screw 50 is rotationally disposed within housing interior 41 in meshed engagement with lead screw 12. Nut screw 50 also includes a shaft 52 and a continuous helical thread 54. The lead and pitch of nut screw thread 54 is identical to that of lead screw 20. The end walls of each shell half 42 and 44 also have a second set of notches 49, which form openings for receiving nut screw 50. The ends of nut screw 50 are journaled in bushing 56, which are seated in a second set of screw openings in housing 22. Thrust bearings 58 are mounted between flat washers 57 on each end of nut screw 50, which rest against bushing 56.

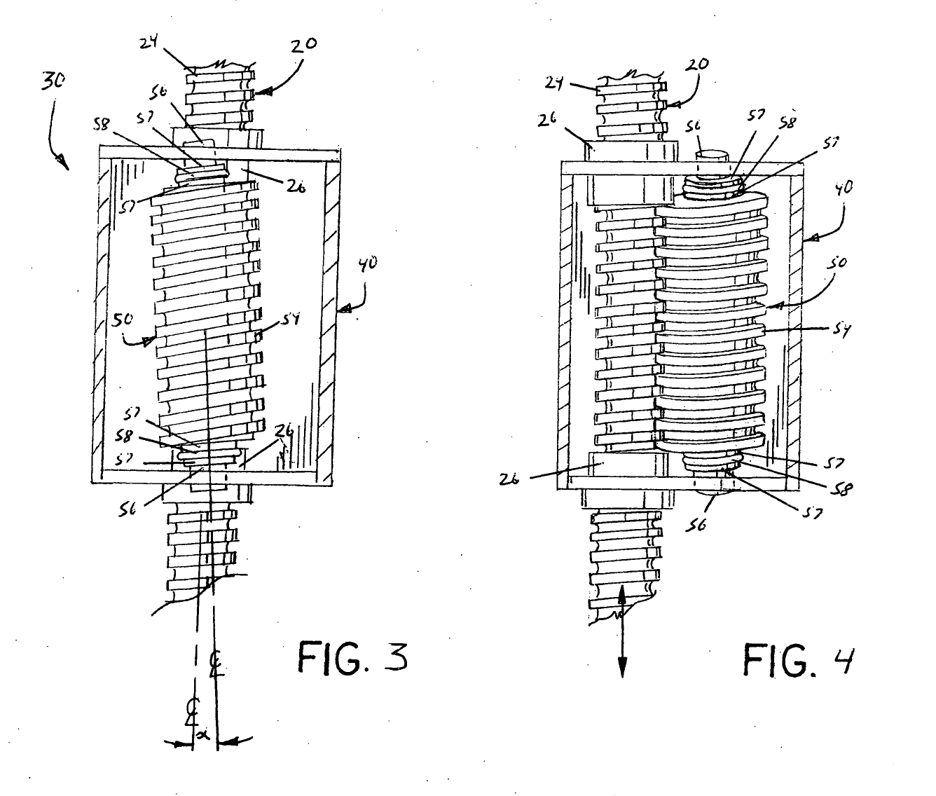

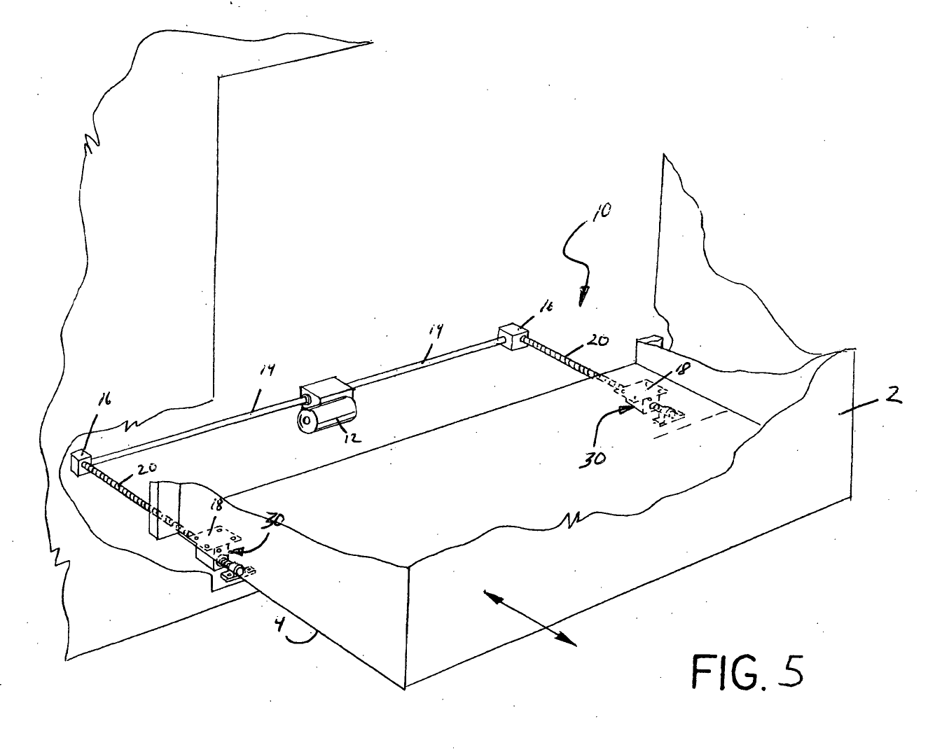

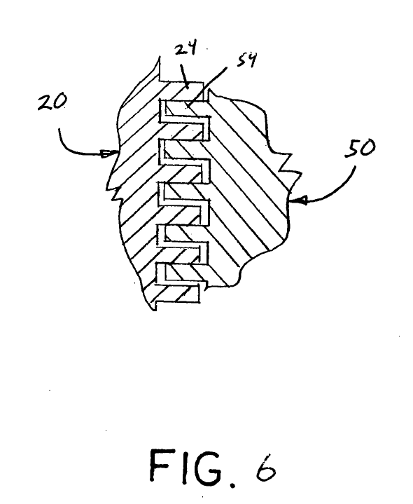

As shown in FIGS. 3 and 4, the axis of rotation of nut screw 50 is parallel to the axis of rotation of lead screw 20 in two dimensional planes, but skewed at an angle (α) in the third dimensional plane. The depth of nut screw notches 49 from the top edge of the end walls in shell halves 42 and 44 are set to seat nut screw 50 so that its axis of rotation is skewed at an angle α, which is approximately equivalent to the pitch of the threads of lead screw 20 and nut screw 50. As illustrated in the top plan view as illustrated in FIG. 3, the axis of rotation of lead screw 20 and nut screw 50 are parallel within a horizontal plane. As illustrated in a side plan view of FIG. 4, the axis of rotation of nut screw 50 is skewed at an angle α with respect to the axis of rotation of lead screw 20 within a vertical plane.

The orientation of the nut screw to the lead screw and the operative engagement between lead screw and nut screw allows a portion of the load to be transferred to the thrust bearings, thereby reducing the sliding friction of the traveler nut under load. The meshed engagement between the lead screw and nut screw provides enough friction under load to ensure that the nut screw turns with the rotation of the lead screw. The majority of the load is carried by the thrust bearings. Transferring the majority of the load to the thrust bearings greatly enhances the power efficiency of the lead screw assembly.

FIG. 5 shows a typical application of an embodiment of the lead screw assembly 10 in a recreational vehicle (RV) slide-out room 2. A pair of lead screws 20 are operatively connected to a drive motor 12 by a pair of linages 14 and gear boxes 16. A mounting plate 18 welded or otherwise secured to traveler nut 30 is secured to the floor 4 or sub-frame of slide-out room 2. Rotation of lead screw 20 reciprocates traveler nut 30 along its length to extend and retract slide-out room 2 from the RV sidewall 6.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A lead screw assembly comprising:
a lead screw; and a traveler nut operatively mounted to the lead screw, whereby the lead screw extends rotationally through the traveler nut,
the traveler nut includes a housing defining an interior, a second screw rotationally disposed within the housing interior in meshing engagement with the lead screw, and a thrust bearing seated in the housing for rotationally supporting the second screw within the housing interior.

2. The lead screw assembly of claim 1 wherein the second screw is oriented within the housing with respect to the lead screw so that the second screw is parallel to the axis of rotation of the lead screw in a first dimensional plane, but skewed at an angle in a second plane orthogonal to the first plane.

3. The lead screw assembly of claim 1 wherein the lead screw has a continuous helical thread, the thread having a pitch, the second screw skewed at an angle in the second plane substantially equal to the pitch of the helical thread of the lead screw.
